(19) United States
(12) Patent Application Publication
(10) Pub. No.: US 2012/0311229 A1
(43) Pub. Date: Dec. 6, 2012

(54) SYSTEM AND METHOD FOR RECORDING NUMBER OF POWER ON TIMES OF MOTHERBOARD

(75) Inventors: HAI PENG, Shenzhen City (CN); QI-WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/214,259

(22) Filed: Aug. 22, 2011

(30) Foreign Application Priority Data
May 30, 2011 (CN) 201110141788.4

(51) Int. Cl. G06F 12/00

(52) U.S. Cl. 711/102; 711/E12.001

(57) ABSTRACT

A powering on times recording system records powering on times of a motherboard, and includes a Basic Input/Output System (BIOS) Read Only Memory (ROM) chip installed on the motherboard. The BIOS ROM chip includes a first storage area storing a recording module and a second storage area storing a first variable data. When the motherboard is powered on, the recording module acquires the first variable data from the second storage area and increments the first variable data by one. The changed first variable data is recorded in the second storage area.

### BACKGROUND

1. Technical Field

The present disclosure relates to recording systems, and particularly, to a system and method for recording number of times that a motherboard has been powered on.

2. Description of Related Art

Storage devices, such as hard disks, are used to record the number of times that a motherboard has been powered on. When an old hard disk is replaced, a new hard disk will record on the number of times that the motherboard has been powered on starting from zero. However, the actual number of times of the motherboard includes the times recorded in both of the new and old hard disks. The number of times that the motherboard has been powered on, recorded in the new hard disk, is not correct.

Therefore, it is desirable to provide a system and method, which can overcome the limitations described.

### BRIEF DESCRIPTION OF THE DRAWINGS

FIG. 1 is a schematic view of a recording system in accordance with an exemplary embodiment.

FIG. 2 is a flowchart of a recording method in accordance with an exemplary embodiment.

### DETAILED DESCRIPTION

Embodiments of the disclosure will now be described in detail, with reference to the accompanying drawings.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

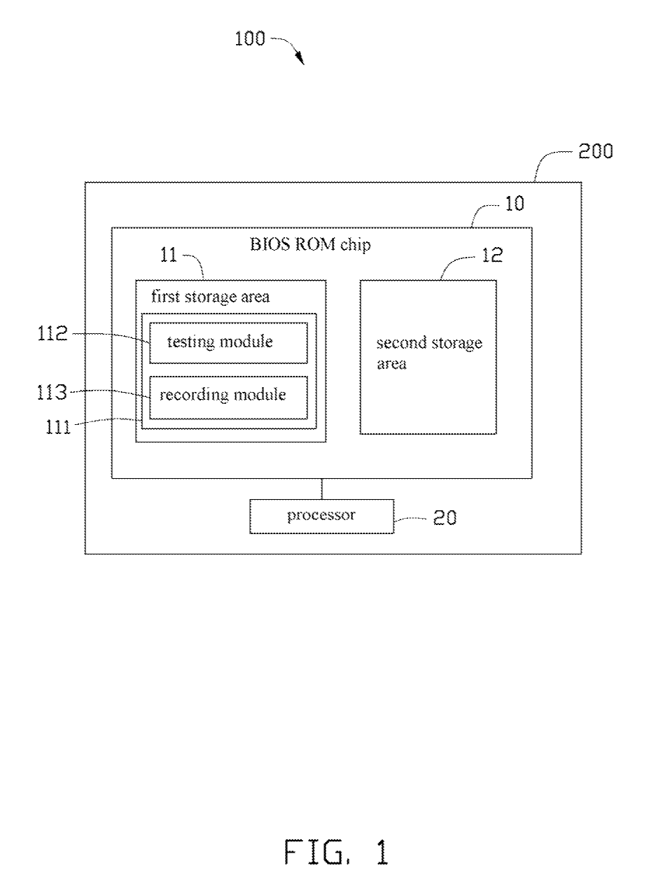

Referring to FIG. 1, a recording system 100, according to an exemplary embodiment, records the number of times that a motherboard 200 has been powered on. The powering on times recording system 100 includes a Basic Input/Output System (BIOS) Read Only Memory (ROM) chip 10, and a processor 20 electrically connected to the BIOS ROM chip 10. The BIOS ROM chip 10 is installed onto the motherboard 200. It should be understood that a plurality of other hardware, such as memory, for example, are also installed on the motherboard 200. In one embodiment, the BIOS ROM chip 10 can be soldered onto the motherboard 200. The processor 20 may execute one or more computerized codes stored in the BIOS ROM chip 10.

The BIOS ROM chip 10 includes a first storage area 11 and a second storage area 12. A bootstrap module 111 is stored in the first storage area 11, and includes a test module 112 and a recording module 113. The test module 112 is for initializing and testing the hardware, such as memory, and guiding into an operating system. The recording module 113 starts running after the test module 112 starts running.

The second storage area 12 is a Non-Volatile Random Access Memory (NVRAM), and stores variable data. The recording module 113 can modify the variable date stored in the NVRAM. In one embodiment, a first variable data is stored in the second storage area 12. The first variable data is data that records the number of times that the motherboard 200 has been powered on.

In use, the motherboard 200 runs the test module 112 after power has been supplied to the motherboard 200. The test module 112 starts to initialize and test the hardware, such as memory, installed on the motherboard 200. When the test module 112 has initialized and tested the hardware, the motherboard 200 is considered to be powered on. The recording module 113 acquires the first variable data from the second storage area 12 and increments the first variable data by one. For example, if the first variable data stored in the second storage area 12 is one hundred and fourteen, the first variable data is incremented to one hundred and fifteen. The changed first variable data is recorded in the second storage area 12. The processor 20 acquires the changed first variable data and displays it on a user interface (UI). Therefore, a user can visually acquire number of times that a motherboard 200 has been powered on.

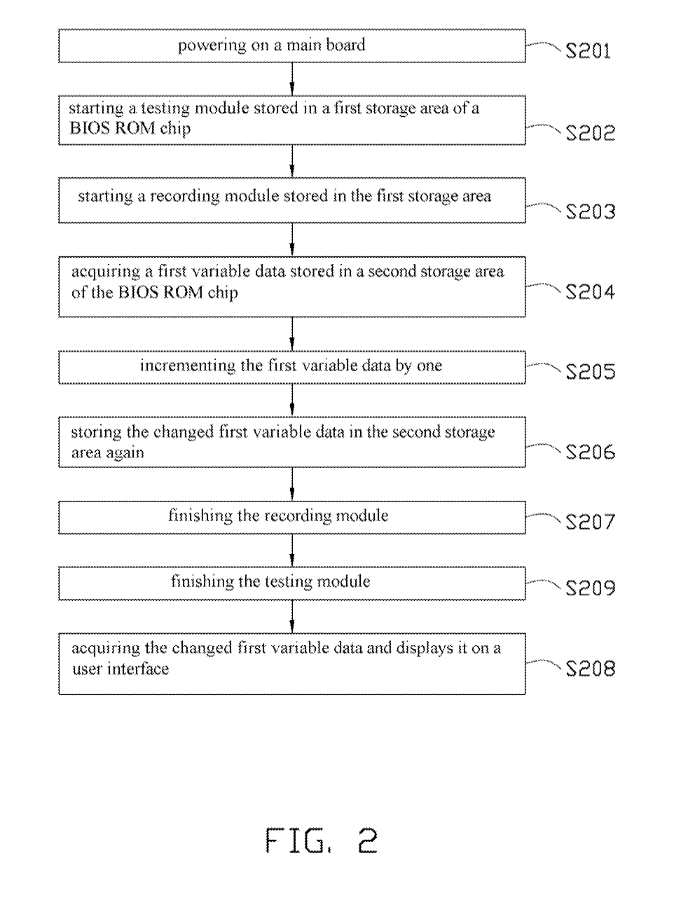

FIG. 2 shows a flowchart of an exemplary method for recording number of times that the motherboard 200 has been powered on. In this embodiment, the powering on times recording method includes the following steps S201-S209. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

In step S201, the motherboard 200 is supplied with power and the BIOS ROM chip 10 of the motherboard 200 includes the first storage area 11 and the second storage area 12.

In step S202, the testing module 112 stored in the first storage area 11 starts running, the test module 112 initializes and tests the hardware installed on the motherboard 200.

In step S203, the recording module 113 stored in the first storage area 11 starts running, the recording module 113 records powering on times of the motherboard 200.

In step S204, the recording module 113 acquires a first variable data stored in the second storage area 12, the first variable data records number of times that the motherboard 200 has been powered on.

In step S205, the recording module 113 increments the first variable data by one.

In step S206, the recording module 113 stores the changed first variable data in the second storage area 12.

In step S207, the recording module 113 finishes running.

In step S208, the testing module 112 finishes running.

In step S209, the processor 20 acquires the changed first variable data and displays it on a user interface (UI).

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A recording system comprising:
a motherboard comprising a Basic Input/Output System (BIOS) Read Only Memory (ROM) chip, the BIOS ROM chip comprising:
a first storage area that stores a recording module; and
a second storage area that stores a first variable data, the first variable data recording a number of times that the motherboard has been powered on;
when the motherboard is powered on, the recording module acquires the first variable data from the second storage area and increments the first variable data by one, the changed first variable data is recorded in the second storage area.

2. The recording system of claim 1, wherein the second storage area is a Non-Volatile Random Access Memory (NVRAM).

3. The recording system of claim 1, wherein the BIOS ROM chip is soldered onto the motherboard.

4. The recording system of claim 1, wherein the first storage area further stores a test module, the test module initializing and testing hardware installed on the motherboard.

5. The recording system of claim 1, wherein when the test module has initialized and tested the hardware, the motherboard is considered to be powered on.

6. A computer-implemented recording method, comprising:
starting a Basic Input/Output System (BIOS) Read Only Memory (ROM) chip installed on a motherboard;
acquiring a first variable data stored in the BIOS ROM chip, the first variable date configured for recording the number of times that a motherboard has been powered on;
incrementing the first variable data by one;
storing the changed first variable data in the BIOS ROM chip.

7. The computer-implemented recording method of claim 6, wherein the BIOS ROM chip comprises a first storage area storing a recording module and a second storage area storing the first variable data, the recording module is configured for acquiring the first variable data and incrementing the first variable data by one.

8. The computer-implemented recording method of claim 7, wherein the first storage area further stores a testing module, the test module initializing and testing hardware installed on the motherboard.

9. The computer-implemented recording method of claim 8, wherein when the test module has initialized and tested the hardware, the motherboard is considered to be powered on.
